(19) United States
(12) Patent Application Publication
(10) Pub. No.: US 2009/0057420 A1
(43) Pub. Date: Mar. 5, 2009

(54) Clear Two-Dimensional Code, Article Having Clear Two-Dimensional Code Attached Thereto, Method for Printing Two-Dimensional Code and Method For Displaying Two-Dimensional Code

(75) Inventors: Tatsuya Onoda, Mie (JP); Kazuhiro Miwa, Mie (JP)

Correspondence Address: HEDMAN & COSTIGAN P.C., 1185 AVENUE OF THE AMERICAS, NEW YORK, NY, 10036, US

(73) Assignee: Content Idea of Asia Co., Ltd., Kuwana-shi, Mie (JP)

(21) Appl. No.: 11/887,747

(22) PCT Filed: Apr. 6, 2005
(86) PCT No.: PCT/JP2005/006759

§ 371 Date: Oct. 3, 2007

(51) Int. Cl. G06K 19/06; B41J 2/01

(52) U.S. Cl. 235/494; 235/487; 347/107

(57) ABSTRACT

The present invention relates to a clear two-dimensional code which can be merged with an image without giving a user a feeling of disorder when the clear two-dimensional code is attached to the image and in which a readable situation and the like can be arbitrarily set; an article having the clear two-dimensional code attached thereto; a method for printing the two-dimensional code; and a method for displaying the two-dimensional code. Base cells and data cells are arranged in a matrix, and either the base cells or the data cells are clear. The clear two-dimensional code can be read only when a color shown on the clear cells consisting of either the base cells or the data cells and a color shown or non-clear cells consisting of either the base cells or the data cells have a contrast which can be read by a code recognition apparatus.

### TECHNICAL FIELD

The present invention relates to a two-dimensional code having base cells white or the like and data cells black or the like arranged in a matrix. More particularly, the present invention relates to a clear two-dimensional code in which either the base cells or the data cells are clear; an article having the two-dimensional code attached thereto; a method for printing the two-dimensional code; and a method for displaying the two-dimensional code.

### BACKGROUND ART

A bar code is in wide use because it can be read quickly and correctly. Bar codes indicating the information of commodity management, production management, and the like are attached to various articles. The bar code is classified into a one-dimensional bar code having information arranged in one direction and a two-dimensional bar code having information arranged in longitudinal and widthwise directions so that two-dimensional bar code has a larger amount of information than the one-dimensional bar code. The one-dimensional bar code has been mainly attached to commercially distributed commodities and the like having a small amount of necessary information. On the other hand, the two-dimensional code has an advantage of allowing a large amount of information to be accommodated in a small space, and in addition, owing to recent progress of portable telephones and the like, individuals can read and recognize the two-dimensional code easily. Therefore the two-dimensional code has spread rapidly and is utilized by attaching it to information magazines and pamphlets or displaying it on screens. As information to be stored, text information, internet address information, and the like are listed.

As the two-dimensional code, Code49 (Intermec Technologies Corporation (United States of America)), PDF417 (Symbol Technologies Inc. (United States of America)), Vericode (VERITEC Inc. (United States of America)), DataMatrix (I.D.MATRIX Inc. (United States of America)), QR code (Denso Corporation (Japan)), and the like have been developed and introduced. Of the above-described two-dimensional codes, the Code49, the PDE417, and the like have conventional bar codes stacked one upon another and are called a stack-type two-dimensional code. On the other hand, the QR code, the VeriCode, the DataMatrix, and the like have the form of checkers and are called a matrix-type two-dimensional code. Of these two-dimensional codes, the QR (Quick Response) code developed and introduced by Denso Corporation has been spread and utilized most widely in Japan (see patent document 1).

The minimum unit (black and white square) constituting the QR code is called a cell. The QR code is indicated by the combination of cells and constructed of a position detection pattern (positioning symbol), format information having information such as a timing pattern, an error correction level, and a mask number, data, and an error correction code (Reed-Solomon Code).

To indicate the same amount of information, the QR code uses 1/30 of a space used by existing bar codes. Further owing to three positioning symbols, the QR code can be read at any angles in 360 degrees. The positioning symbols means three (one in micro QR) position detection patterns disposed at three corners of the QR code. By retrieving this pattern, it is possible to recognize the position of the QR code, which enables a high-speed read. When 30% of the area of a data region becomes dirty or is lost, the data of the QR code can be restored and identified. Data for restoring the data which has become dirty or has been lost has the effect of preventing erroneous read and preventing erroneous data from being outputted.

The two-dimensional code such as the QR code is square, and white and black (dark brown) cells are arranged in a matrix therein. Thus the two-dimensional code such as the QR code has a problem that when the two-dimensional code is embedded in a background image in information magazines or pamphlets, the two-dimensional code gives a user a feeling of disorder in terms of design.

When the two-dimensional code is provided in a place where it does not overlap the background to avoid the above-described problem, it is necessary to secure an approximately square exclusive space for the two-dimensional code, which decreases the space for other information.

Further because the two-dimensional code has the above-described color and configuration, the two-dimensional code has a strong contrast and is more conspicuous than displays such as trademarks, headlines of articles, and the like to which attention is desired to be paid to the highest extent.

Furthermore the two-dimensional code attached to an article or the like can be read at any time when a reader or the like is available and can be read in only an arbitrary situation. Thus the two-dimensional code has a problem that a situation at a read time cannot be set.

Patent document 1: Patent No. JP 2938338

### DISCLOSURE OF THE INVENTION

### Problem to be Solved by the Invention

The present invention has been made in view of the above-described problems. It is an object of the present invention to provide a clear two-dimensional code which can be merged with an image without giving a user a feeling of disorder when the clear two-dimensional code is attached to the image and in which a readable situation and the like can be arbitrarily set; an article having the clear two-dimensional code attached thereto; a method for printing the clear two-dimensional code; and a method for displaying the clear two-dimensional code.

### Means for Solving the Problem

A clear two-dimensional code of the present invention has base cells and data cells arranged in a matrix. Either the base cells or the data cells are clear.

In the clear two-dimensional code, only when a color shown on the clear cells consisting of either the base cells or the data cells and a color shown on non-clear cells consisting of either the base cells or the data cells have a contrast which can be read by a code recognition apparatus, the clear two-dimensional code can be read.

The two-dimensional code of the present invention attached to articles includes information that can be obtained by a code recognition apparatus for reading the two-dimensional code. The two-dimensional code is the above-described clear two-dimensional code.

In a method of the present invention for printing on a printing medium a clear two-dimensional code having base cells and data cells which are arranged in a matrix and one of which are clear, only non-clear cells consisting of either the base cells or the data cells are printed by superposition on an image printed on the printing medium.

The above-described “by superposition on an image printed on the printing medium” means that cells are printed on an image already printed on the printing medium or means that an image to be printed on the printing medium is formed on a computer screen. More specifically, it means that a synthesized image is formed by superposition on the image to be printed on the computer screen and thereafter the synthesized image is printed.

In a method of the present invention for displaying on a display apparatus a clear two-dimensional code having base cells and data cells which are arranged in a matrix and one of which are clear, only non-clear cells consisting of either the base cells or the data cells are displayed by superposition on an image displayed on the display apparatus.

In the two-dimensional code, a contrast between black (brown) cells and white cells is read on the basis of a white base area and substituted with signals of 0 or 1 for computerization. When the two-dimensional code was developed and published, it could be read only when the contrast was high such as one between black and white. But in recent years, image-processing technique and reading apparatuses have been highly developed, and error-correcting technique has been established. Therefore even when the two-dimensional code has a low contrast and is contaminated or lost to a low extent, the two-dimensional code can be read in recent years. The present invention has been developed to solve the problems in terms of display of the existing two-dimensional code by utilizing the above-described background technique.

### EFFECT OF THE INVENTION

In the present invention, Because either the base cells or the data cells are clear, the clear two-dimensional code can be embedded in a background image or the like without giving a user a feeling of disorder. Further because the two-dimensional code is embedded in the region of the background image or the like, the two-dimensional code does not occupy a large space and is thus space-saving.

Only when the color shown on the clear cells and the color shown on the non-clear cells have a contrast which can be read by the code recognition apparatus, the two-dimensional code can be read. Therefore it is possible to set a state in which the two-dimensional code is readable or unreadable according to the situation of the background portion of the clear two-dimensional code.

The above-described clear two-dimensional code of the present invention is attached to the article. Therefore the article having the two-dimensional code attached thereto has a fine appearance without giving the user a feeling of disorder and is capable of including various information. Further it is possible to set a state in which the two-dimensional code is readable or unreadable according to the situation of the article.

In the method of the present invention for printing on the printing medium the clear two-dimensional code having base cells and data cells, one of which are clear, only the non-clear cells consisting of either the base cells or the data cells are printed by superposition on the image printed on the printing medium. Therefore the clear two-dimensional code can be printed by embedding it in the image printed on the printing medium without giving the user a feeling of disorder.

In the method of the present invention for displaying on the display apparatus the clear two-dimensional code having base cells and data cells, one of which are clear, only the non-clear cells consisting of either the base cells or the data cells are displayed by superposition on the image displayed on the display apparatus. Therefore the clear two-dimensional code can be displayed by embedding it in the image displayed on the display apparatus without giving the user a feeling of disorder.

### BRIEF DESCRIPTION OF THE DRAWINGS

FIG. 1 shows the construction of a clear two-dimensional code of the present invention.

FIG. 2 shows an embodiment of the clear two-dimensional code of the present invention.

FIG. 3 shows another embodiment of the clear two-dimensional code of the present invention.

FIG. 4 shows one embodiment of an article having a two-dimensional code of the present invention attached thereto.

### EXPLANATION OF REFERENCE NUMBER AND SYMBOLS

1: clear two-dimensional code
2: base cell
3: data cell
4: position detection pattern
5: background image
6: PET bottle

### BEST MODE FOR CARRYING OUT THE INVENTION

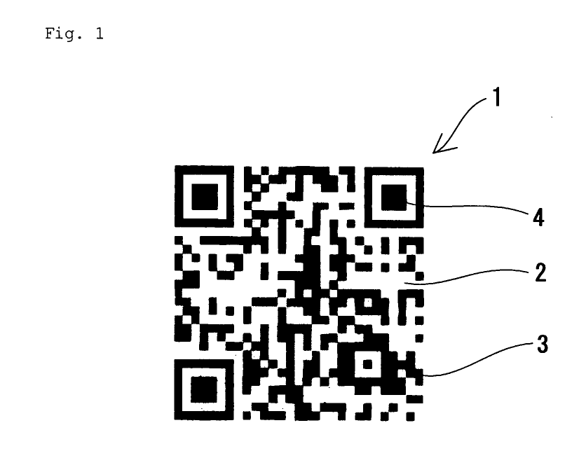

As shown in FIG. 1, a clear two-dimensional code 1 of the present invention has base cells 2 and data cells 3 arranged in a matrix. Either the base cells 2 or the data cells 3 are clear. The base cells 2 and the data cells 3 are both minimum units constituting a two-dimensional code and are square unit cells.

The above-described “clear” means a state in which the relevant cells are transparent, and an image or a substance disposed at a side opposite to a side at which the cells are read by a code recognition apparatus (hereinafter referred to as code back side) is seen through the cells. More specifically, the cells are made clear by not printing them or not displaying them, and the image or the like at the code back side remains on the cells as it is. When the image or the substance at the code back side is transparent, the design and color of an image, a landscape, a substance, and the like disposed at the back of the image or the substance at the code back side are seen in the clear cells.

The clear two-dimensional code of the present invention can be based on a conventional arbitrary two-dimensional code. It is preferable that the clear two-dimensional code is based on the QR code because the QR code has spread at a high percentage in Japan. In this case, in combination of the base cells and the data cells, position detection patterns (positioning symbols) 4, a timing pattern, format information, data, an error correction code (Reed-Solomon Code), and the like are constituted.

As the code recognition apparatus for reading the two-dimensional code, a code-reading scanner and a portable telephone corresponding to the read of the two-dimensional code are listed. According to the kind of the code recognition apparatus, there is a difference in the readable size (region) of a code, in the readable contrast between the base cells and the data cells, or the like. Therefore it is preferable that the clear two-dimensional code of the present invention has a size corresponding to a code recognition apparatus which is supposed to be mainly used by a user.

In the clear two-dimensional code of the present invention, either the base cells or the data cells are clear. Therefore the two-dimensional code can be read only in the case where the color shown on the clear cells and the color shown on the non-clear cells have a contrast which can be read by the code recognition apparatus.

The color of the base cells 2 is set to white or a color having a high lightness, whereas the color of the data cells 3 is set to black, dark brown or a color having a low lightness. Thus which of the base cells 2 or the data cells 3 are set as the clear cells depends on the situation of an image and the like constituting the background. That is, when many bright portions are included in an image and the like at the code back side, the base cells 2 are set as the clear cells, whereas when many dark portions are included in the image and the like at the code back side, the data cells 3 are set as the clear cells. This way of setting the clear cells is hereinafter referred to as “selection of clear cells”.

The color of the base cells 2 can be read by the code recognition apparatus when the color thereof has a predetermined contrast in relation to the color of the data cells 3. Thus when the data cells 3 are set as the clear cells, the color of the base cells 2 can be determined in the above-described readable range. Similarly the color of the data cells 3 can be read by the code recognition apparatus when the color thereof has a predetermined contrast in relation to the color of the base cells 2. Thus when the base cells 2 are set as the clear cells, the color of the data cells 3 can be determined in the above-described readable range.

It is preferable that in the clear two-dimensional code 1, in consideration of the color of the image and the like at the code back side, the color of the cells not set as the clear cells is set to a possible brightest color, a possible darkest color or a color possible similar to that of the image at the code back side in the above-described readable range. This way of setting the color of the non-clear cells is hereinafter referred to as “selection of cell color”. By appropriately selecting the color, the two-dimensional code can be merged with the image without giving the user a feeling of disorder.

As the position to which the two-dimensional code is attached, it is preferable to appropriately select a position where the image at the code back side has little color change.

In the method of the present invention for printing the two-dimensional code, only the non-clear cells consisting of either the base cells or the data cells are printed by superposition on an image to be printed on a printing medium such as paper. At a printing time, it is preferable to perform printing after the above-described “selection of clear cells” and “selection of cell color” are performed.

As the method for printing the two-dimensional code, it is possible to carry out a method of printing the two-dimensional code by superposition on the image already printed by utilizing a printer or the like; or a method of forming a synthesized image of a background image and the two-dimensional code on a computer by utilizing an image editing software or the like and thereafter printing the synthesized image.

In the method of the present invention for displaying the two-dimensional code, only the non-clear cells consisting of either the base cells or the data cells are displayed on a to-be-displayed portion of a display apparatus such as a monitor by superposition on an image to be displayed. At a display time, it is preferable to display the two-dimensional code after the above-described “selection of clear cells” and “selection of cell color” are performed.

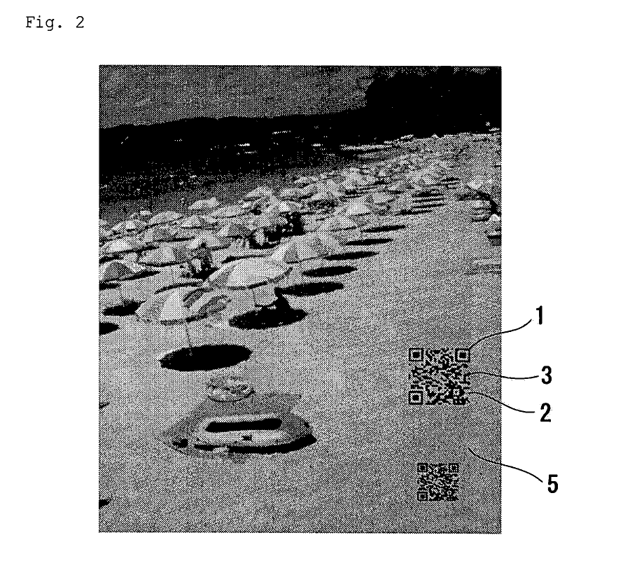

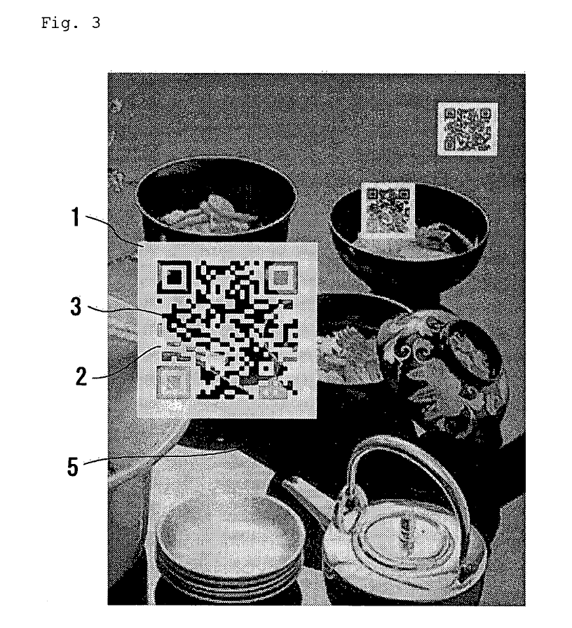

One embodiment of the clear two-dimensional code of the present invention is described below with reference to FIGS. 2 and 3. FIG. 2 shows an example in which the two-dimensional code having the base cells set as the clear cells is printed on a printing medium. FIG. 3 shows an example in which the two-dimensional code having the data cells set as the clear cells is printed on a printing medium.

In the example shown in FIG. 2, because a background image 5 to which the clear two-dimensional code 1 is attached is comparatively bright, only the black data cells 3 are printed by superposition on the background image 5, whereas the base cells 2 are clear. In the example shown in FIG. 3, because the background image 5 to which the clear two-dimensional code 1 is attached is comparatively dark, only the white base cells 2 are printed by superposition on the background image 5, whereas the data cells 3 are clear.

The clear two-dimensional code of the present invention can be attached to paper medium, all printable printing mediums, all electronic images which can be displayed on an image display apparatus, and all media such as metal, glass, ceramics, plastics, and the like on which the two-dimensional code can be displayed after these media are processed.

In the article to which the two-dimensional code of the present invention is attached, the clear two-dimensional code of the present invention is attached to an arbitrary position of the article. As the article, paper medium, all printable printing mediums, all media such as metal, glass, ceramics, plastics, and the like on which the two-dimensional code is displayed after these media are processed, and the like are listed.

As described above, only when the color shown on the clear cells consisting of either the base cells or the data cells and the color shown on the non-clear cells consisting of either the base cells or the data cells have a contrast which can be read by the code recognition apparatus, the clear two-dimensional code can be read. Utilizing this, description is made below on examples in which a situation at a read time can be arbitrarily set, for example, a situation in which the two-dimensional code cannot be read is intentionally made.

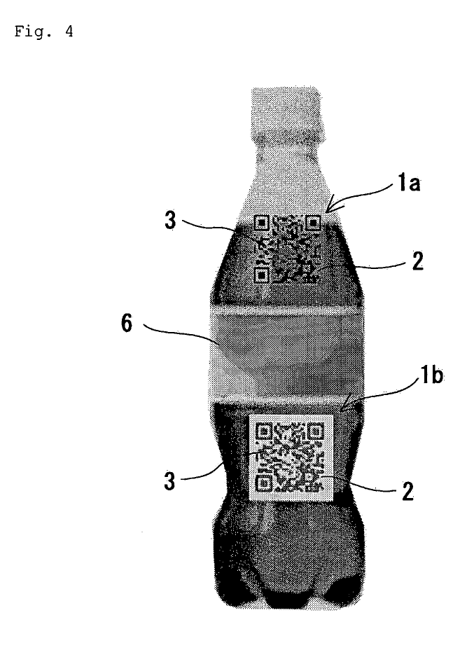

As an example of the article to which the two-dimensional code of the present invention is attached, a PET bottle to which the clear two-dimensional code is attached is described below with reference to FIG. 4.

Clear two-dimensional codes 1a and 1b are attached to a side surface of a PET bottle 6. The clear two-dimensional codes 1a and 1b are attached to the side surface of the PET bottle 6 by directly printing them on the surface thereof or on a transparent portion of a label film. In FIG. 4, in the clear two-dimensional code 1a disposed at an upper portion of the PET bottle 6, the data cells 3 are black, whereas the base cells 2 are clear. Thus the color of a content of the PET bottle 6 is visible at the base cells 2. In the clear two-dimensional code 1b disposed at a lower portion of the PET bottle 6, the base cells 2 are white, whereas the data cells 3 are clear. Thus the color of the content of the PET bottle 6 is visible at the data cells 3.

Therefore when the PET bottle 6 contains a dark substance such as cola, the clear two-dimensional code 1a cannot be read when the cola is contained in the PET bottle 6, whereas the clear two-dimensional code 1a can be read when the cola is all drunk. On the other hand, the clear two-dimensional code 1b can be read when the cola is contained in the PET bottle 6, whereas the clear two-dimensional code 1b cannot be read when the cola is all drunk. Let it be supposed that the two-dimensional code 1a includes information such as “success”/“failure”. When the PET bottle 6 is bought, whether “success” or “failure” is unclear. As the cola is drunk after it is bought, the two-dimensional code can be read and whether “success” or “failure” becomes clear.

As described above, a producer can set a situation, for example, the time when the clear two-dimensional code of the present invention attached to the article can be read. Further the clear two-dimensional code 1a itself shown in FIG. 4 can be hardly recognized with eyes when the content (cola) is contained in the PET bottle 6. Thus the clear two-dimensional code has a fine appearance without giving the user a feeling of disorder.

Other examples in which a situation at a read time can be arbitrarily set are described below.

(1) An example in which by attaching the clear two-dimensional code to glass, the clear two-dimensional code can be read in the daytime and cannot be read in the nighttime.

(2) An example in which by printing the clear two-dimensional code on a filmlike material or on a specific place, the clear two-dimensional code can be read only at an arbitrary place, on a page or in an image.

(3) An example in which the color of a background, an image, and a moving picture are displayed on a monitor by displaying the clear two-dimensional code on an outermost surface thereof so that the clear two-dimensional code can be read only at an arbitrary place, time, and in the image.

(4) An example in which the clear two-dimensional code is displayed by means of a temperature change, irradiation of arbitrary light beams and the like.

As described above, a producer can set a read situation by design when the producer produces the clear two-dimensional code of the present invention and give various read conditions to the user. In addition, the producer can assimilate the clear two-dimensional code to the background to make it inconspicuous.

### INDUSTRIAL APPLICABILITY

The clear two-dimensional code of the present invention can be merged with an image when the clear two-dimensional code is attached to the image without giving the user a feeling of disorder and is space-saving. Thus the clear two-dimensional code can be preferably attached to pamphlets, information magazines, and the like. Further, because a readable situation and the like can be arbitrarily set in the clear two-dimensional code, it can be preferably attached to articles such as a PET bottle.

1. A clear two-dimensional code comprising base cells and data cells, wherein both said base cells and said data cells are arranged in a matrix, and either said base cells or said data cells are clear.

2. The clear two-dimensional code according to claim 1, wherein only when a color shown on clear cells consisting of either said base cells or said data cells and a color shown on non-clear cells consisting of either said base cells or said data cells have a contrast which can be read by a code recognition apparatus, said clear two-dimensional code can be read.

3. An article provided with a two-dimensional code including information that can be acquired by said code recognition apparatus for reading said two-dimensional code,
wherein said two-dimensional code is said clear two-dimensional code according to claim 1 or 2.

4. A method for printing said two-dimensional code, whereby said clear two-dimensional code comprising said base cells and said data cells which are arranged in a matrix and one of which are clear are printed on a printing medium,
wherein only said non-clear cells consisting of either said base cells or said data cells are printed by superposition on an image on said printing medium.

5. A method for displaying said two-dimensional code, whereby said clear two-dimensional code comprising said base cells and said data cells which are arranged in a matrix and one of which are clear are displayed on a display apparatus,
wherein only said non-clear cells consisting of either said base cells or said data cells are displayed by superposition on an image on said display apparatus.
